(19) United States
(12) Patent Application Publication
(10) Pub. No.: US 2017/0136417 A1
(43) Pub. Date: May 18, 2017

(54) MEMBRANES WITH SACRIFICIAL COATINGS

(71) Applicant: OSMOFLO PTY LTD, Burton, South Australia (AU)

(72) Inventors: Hiep Thanh Huynh LE, Ferryden Park (AU); Marcus John FABIG, Henley Beach (AU)

(21) Appl. No.: 15/126,791

(22) PCT Filed: Mar. 17, 2015
(86) PCT No.: PCT/AU2015/000151

§ 371 Date: Sep. 16, 2016

(30) Foreign Application Priority Data
Mar. 17, 2014 (AU) 2014900902

(51) Int. Cl. B01D 65/02; C02F 1/44; B01D 65/08; B01D 69/06; B01D 67/00; B01D 61/02

(52) U.S. Cl. CPC B01D 65/02; B01D 67/0088; B01D 61/025; B01D 65/08; B01D 69/06; C02F 1/441; B01D 2321/08; B01D 2321/168; C02F 2303/16; C02F 2303/20; C02F 2303/22

(57) ABSTRACT

A method for controlling scale and/or fouling on a separation membrane. The method comprises forming a thermally, physically, electrically or chemically degradable coating layer on the membrane; using the membrane under conditions that result in the formation of scale and/or fouling species on the membrane; and removing at least some of the scale and/or fouling species from the membrane by thermally, physically, electrically or chemically degrading the coating layer.

### PRIORITY DOCUMENT

The present application claims priority from Australian Provisional Patent Application No. 2014900902 titled “MEMBRANES WITH SACRIFICIAL COATINGS” and filed on 17 Mar. 2014, the content of which is hereby incorporated by reference in its entirety.

### TECHNICAL FIELD

The present invention relates generally to separation membranes and more specifically to membranes used for water and wastewater purification.

### BACKGROUND

Reverse Osmosis (RO) is a cross-flow separation technology that uses a pump and a semi-permeable membrane (a “separation membrane”) to separate dissolved salts from a liquid, which is typically water. The separation membrane allows water and some ions to pass, but retains most of the dissolved salt, thereby providing a purified product water stream. Reverse osmosis is used extensively for the desalination of sea water and brackish water and for removing or reducing total dissolved solids and residual organic compounds from various water sources, such as from natural water sources, municipal water supply or industrial effluents.

Forward osmosis (FO) is another cross-flow separation technology which uses a semi-permeable membrane to separate water from dissolved solutes. The driving force in FO separations is an osmotic pressure gradient. Specifically, the permeate side of the FO membrane contains a salt “draw” solution which has a higher osmotic potential than the feed water on the other side of the membrane and the higher osmotic potential in the draw solution drives the filtration process so that water moves through the membrane and is filtered in the process.

Nanofiltration (NF) is still another cross-flow separation technology which ranges somewhere between ultrafiltration and reverse osmosis. Again, the separation process takes place on a selective separation layer formed by a semi-permeable separation membrane. RO and NF processes are pressure driven with the driving force of the separation process being the pressure difference between the feed (retentate) and the filtrate (permeate) side of the separation membrane.

Electrodialysis (ED) is another membrane separation technology which uses ion exchange (IX) membranes to separate ions from water. ED is based on the principal that most dissolved solutes are positively and negatively charged and they will migrate to electrodes with an opposite charge. A typical ED system consists of a membrane stack with a number of cell pairs, each consisting of a cation transfer membrane, a product flow spacer, an anion transfer membrane and a concentrate flow spacer, and compartments for the electrodes at the opposite ends of the stack. The anions in the feed water are able to pass through the anion selective membrane, but are not able to pass by the cation selective membrane, which blocks their path and traps the anions in the concentrate stream. Similarly, cations move in the opposite direction through the cation selective membrane under a negative charge and are trapped by the anion selective membrane.

Electrodialysis reversal (EDR) is similar to ED but the polarity is regularly reversed, thereby freeing accumulated ions on the membrane surface. This process minimises the effects of inorganic scaling and fouling by converting product streams into waste streams.

Membrane capacitive deionisation (MCDI) is another membrane separation technology which uses ion exchange (IX) membranes to separate ions from water. The process is based on applying a cell voltage between two oppositely placed porous electrodes sandwiching a spacer channel that transports the water to be desalinated. In the salt removal step, ions are adsorbed at the electrode-water interface within the micropores inside the porous electrodes. After the electrodes reach a certain adsorption capacity, the cell voltage is reduced or even reversed, which leads to ion release from the electrodes and a concentrated salt solution in the spacer channel, which is flushed out, after which the cycle can start over again. IX membranes are positioned in front of each porous electrode and prevent the co-ions from leaving the electrode region during ion adsorption, while also allowing for ion desorption at reversed voltage. Both effects significantly increase the salt removal capacity of the system per cycle.

In RO, FO, NF, ED, EDR and MCDI processes, efficiency and water recovery is often limited by mineral scale formation from hardness compounds, such as calcium, magnesium, barium, iron, fluoride, sulfate, carbonate and silica or silicate salts on membrane surfaces. Residual organic compounds and biological proliferation can also cause membrane fouling. Therefore, it is necessary to periodically clean separation membranes to remove scaling or fouling materials from the surface.

In a conventional RO, FO or NF water purification process, the water recovery rate (i.e. the percentage of the permeate recovery from the feed water) is often limited to the range of 65-80%, depending on the feed water quality and extent of pretreatment. As such, a large amount of the membrane concentrate (or “reject”) has to be further treated or disposed of. Concentrate is typically sent to a sewer or otherwise wasted, possibly after some treatment to meet discharge permit requirements. We previously developed a method for maximizing the recovery of permeate water from feed water from a separation membrane based apparatus using a control system to continually drive the membrane at or beyond the threshold of scaling based on membrane operating conditions rather than a control system based on set-points pre-determined from a membrane manufacturer's design guideline to prevent scale formation (Australian Patent No. 2007262651). This enables operation of the apparatus at or beyond the membrane scaling threshold to maximize product water recovery. However, this results in operation of the membrane separation unit well beyond conventional design guidelines.

In a conventional ED, EDR or MCDI water purification process, the water recovery rate is higher than conventional RO, FO or NF process due to those former processes rejecting a lower rate of ions, thereby, concentrating to a lower level than the latter processes.

The feed water in RO, FO, NF, ED, EDR and MCDI water purification processes often contains sparingly soluble salts, such as carbonate scale, sulfate scale, silica, metals and the like which have a very low solubility and a high potential for scaling on a membrane surface. Similarly, organic salts and microorganisms in the feed water are also deposited on the membrane surface and on the spacers, and this phenomenon is known as membrane fouling. Membrane scaling and fouling causes a higher energy use, shorter life span of the membranes, and can lead to complete failure of the membranes.

One method of controlling scale is to add acid to the feed water. This is effective but has some drawbacks because it can be detrimental to the membrane and reduce the use time before replacement is needed. Addition of acid can also be cost prohibitive for large systems and there are safety concerns with the use of acids in such systems. Furthermore, with some feed water applications the complex nature of the scale formation can reduce the ability for acid to effectively remove the accumulated material on the membrane surface, even to the point whereby the scale becomes irreversibly attached to the membrane.

An example of a method of cleaning RO membranes is disclosed in Japanese Patent Application Laid-open No. 2008-132421. In the disclosed method, water with a pH of 9.5 or greater is filtered through the reverse osmosis membrane to decompose and remove organic matter adhered to the membrane. A chelating scale inhibitor such as ethylenediaminetetraacetic acid (EDTA) is usually also used in these alkaline cleaning methods.

These prior art methods involve the addition of chemicals, such as acids, alkalis, complexing agents and other aggressive chemical agents, that not only add cost to the overall process but also present health and environmental concerns with their use. As discussed, with some feed water applications the complex nature of the scale formation also means that many of the additives used are not capable of effectively removing the accumulated material on the membrane surface and, in some cases, can result in the scale becoming irreversibly attached to the membrane.

In published international patent application WO2012158717A2 Advanced Hydro disclose a method for removing foulant cake from a membrane surface having a polydopamine coating by soaking and flushing the membrane with water at 100 to 140° F. (37 to 60° C.). The ability to regenerate the membrane with hot water and without using any additional chemicals is attributed to the hydrophilicity of the coating. However, in practice it is found that some scaling species have inverse solubility characteristics (i.e. they become less soluble as the temperature increases) and this affects the efficiency of the hot water soak and flush. Advanced Hydro also disclose that the polydopamine membrane coating can be stripped from the membrane surface using bleach. However, this particular method suffers from the same drawbacks as earlier membrane cleaning methods that use acid or base in that aggressive chemical agents have to be used.

In U.S. Pat. No. 8,685,252 diatomaceous earth, activated carbon and bentonite particles are used on a membrane surface to provide anti-fouling properties. Hydrophilic dendritic polymers have also been used on membrane surfaces for their antifouling properties (U.S. Pat. No. 8,505,743).

There is a need for methods of cleaning separation membranes to remove or reduce scale adhered to the membranes that overcome one or more of the problems associated with prior art methods.

There is also a need for methods of reducing the scaling rate and increasing the time between cleaning.

### SUMMARY

We have previously investigated the use of hot water (>45° C.) for removing scale and/or fouling species from membranes in RO and NF water purification systems. We did this despite the fact that many membranes are not suited to being exposed to the increased temperatures and, indeed, the higher temperatures required may exceed many membrane manufacturers' guidelines. Whilst we found that very hot (50-99° C.) water can be used to remove scale and/or fouling species from separation membranes there can be difficulties arising from the fact that some scaling species have inverse solubility characteristics (i.e. they become less soluble as the temperature increases). The present invention arises from our continued research in this area and, in particular, our finding that separation membranes can be coated with a coating layer of a material that can be degraded thermally, physically or chemically so that the coating layer can be deliberately degraded and separated from the membrane, resulting in removal of scale and/or fouling species attached to the coating.

In a first aspect, provided herein is a method for controlling scale and/or fouling on a separation membrane, the method comprising:
forming a thermally, physically, electrically or chemically degradable coating layer on the membrane;
using the membrane under conditions that result in the formation of scale and/or fouling species on the membrane; and
removing at least some of the scale and/or fouling species from the membrane by thermally, physically, electrically or chemically degrading the coating layer.

In certain embodiments, the method of the first aspect further comprises: detecting the formation of scale and/or fouling species on the membrane and, once a threshold level of scale and/or fouling species is detected, initiating a membrane cleaning cycle comprising removing at least some of the scale and/or fouling species from the membrane by thermally, physically, electrically or chemically degrading the coating layer.

In certain embodiments, the method further comprises forming the thermally, physically, electrically or chemically degradable coating layer on the membrane in situ by dosing a feed water supply line for supplying feed water to the membrane with a coating agent under conditions to form the coating layer on the membrane.

In a second aspect, provided herein is a separation membrane comprising a membrane and a coating layer on the membrane, wherein the coating layer is thermally, physically, electrically or chemically degradable and whereby degradation of the coating layer results in removal of at least some of the scale and/or fouling species from the membrane.

In a third aspect, provided herein is a method of cleaning a separation membrane of the second aspect of the invention to remove or reduce scale and/or fouling species therefrom, the method comprising:
contacting the membrane with a heated fluid at an elevated temperature that is above the standard operating temperature of the membrane; and/or
contacting the membrane with a fluid containing at least one degrading agent; and/or
exposing the membrane to ultrasonic radiation, microwave radiation, a magnetic field or an electric current;
   for a predetermined period of time to thermally, physically, electrically and/or chemically degrade the coating layer and remove at least some of the scale and/or fouling species from the membrane.

In a fourth aspect, provided herein is a method for controlling scale and/or fouling on a separation membrane according to the second aspect of the invention, the method comprising detecting the formation of scale and/or fouling species on the membrane and, once a threshold level of scale and/or fouling formation is detected, initiating a membrane cleaning cycle comprising contacting the membrane with a heated fluid at an elevated temperature that is above the standard operating temperature of the membrane and/or a fluid containing at least one degrading agent and/or ultrasonic radiation, microwave radiation, a magnetic field or an electric current for a predetermined period of time to thermally, physically, electrically and/or chemically degrade the coating layer and remove at least some of the scale and/or fouling species from the membrane.

In certain embodiments of the first to fourth aspects, the coating layer is thermally degradable at an elevated temperature that is above the standard operating temperature of the membrane.

In other certain embodiments of the first to fourth aspects, the coating layer is physically degradable and degrades when exposed to ultrasonic radiation, microwave radiation or a magnetic field.

In other certain embodiments of the first to fourth aspects, the coating layer is electrically degradable and degrades when exposed to an electric current.

In other certain embodiments of the first to fourth aspects, the coating layer is chemically degradable and degrades when in contact with the degrading agent.

In still other certain embodiments of the first to fourth aspects, the coating layer is thermally and chemically degradable. In still other certain embodiments of the first to fourth aspects, the coating layer is thermally and physically degradable. In still other certain embodiments of the first to fourth aspects, the coating layer is physically and chemically degradable. In still other certain embodiments of the first to fourth aspects, the coating layer is thermally and electrically degradable. In still other certain embodiments of the first to fourth aspects, the coating layer is electrically and physically degradable. In still other certain embodiments of the first to fourth aspects, the coating layer is electrically and chemically degradable.

In certain embodiments, the separation membrane is a membrane that is used in a desalination apparatus or plant and is exposed to feed water containing scale forming materials including, but not limited to, calcium carbonate, calcium sulfate, calcium phosphate, strontium sulfate, barium sulfate, calcium fluoride, iron hydroxide or silica.

The predetermined period of time will depend on the amount of scaling or fouling on the membrane, the chemistry of the scaling or fouling species, the temperature of the heated water, the degrading agent(s) used, the cross-flow velocity of the heated water or fluid containing at least one degrading agent on the membrane, the strength of the ultrasonic radiation, microwave radiation or a magnetic field, electric current, etc.

For thermal degradation of the coating layer, the heated fluid may be any liquid that can be heated to the desired temperature and brought into contact with the separation membrane. Water is particularly suitable for this purpose. Advantageously, in these embodiments the water may be substantially free of any added acid(s), alkali(s), oxidant(s) or other cleaning chemicals. This provides an environmentally friendly method for cleaning a separation membrane.

The elevated temperature is above the standard operating temperature of the membrane. The elevated temperature that is used will depend on the particular membrane used and the nature of the coating layer, but typically the elevated temperature will be from about 40° C. to about 99° C. The temperature of the cleaning water is preferably at least about 10° C. higher than the standard operating temperature of the membrane, more preferably at least about 15° C. higher than the standard operating temperature of the membrane, and most preferably about 20° C. higher than the standard operating temperature of the membrane.

For chemical degradation of the coating layer, the degrading agent can be any molecular or ionic species that reacts with the coating layer to degrade the layer. Suitable degrading agents include, but are not limited to, acids, alkalis, salts, complexing agents, and organic species.

For physical degradation of the coating layer, the ultrasonic radiation, microwave radiation or magnetic field can be formed using known apparatus.

For electrical degradation of the coating layer, the electric current can be formed and applied to the coating layer using known apparatus.

In a fifth aspect, the present invention provides a water purification apparatus comprising:
a separation unit comprising a separation membrane according to the second aspect of the invention separating a concentrate side from a permeate side, the concentrate side of the separation unit being configured to receive, during a purifying cycle, water from a feed water supply line and to discharge water not passed through the membrane via a concentrate line, and the permeate side of the separation unit being configured to discharge permeate water that has passed through the membrane via a permeate line;
the concentrate side of the separation unit being configured to receive, during a cleaning cycle, heated water at an elevated temperature that is above the standard operating temperature of the membrane from a water supply line or a fluid containing at least one degrading agent or ultrasonic radiation, microwave radiation, magnetic field or electric current and to discharge water via the concentrate line, and the permeate side of the separation unit being configured to return permeate water that has passed through the membrane to the feed water supply line;
a controller operatively connected to the feed water supply line, the concentrate line and the permeate line and configured to regulate the flow of water through said lines so that the apparatus can be operated in a purifying cycle during which purified water is produced and a cleaning cycle during which scale on the membrane is removed or reduced.

In certain embodiments of the fifth aspect, the water purification apparatus further comprises a preparation and application unit in fluid connection with the feed water supply line, said preparation and application unit configured to introduce a coating agent to the feed water to coat the membrane.

In certain embodiments of the fifth aspect, the water purification apparatus further comprises a heater configured to heat the supply flush water to the elevated temperature.

In certain embodiments of the fifth aspect, the water purification apparatus further comprises a scale removal unit configured to introduce a coating degrading agent into the membrane to chemically degrade the coating layer and reduce the amount of scale on the membrane.

In certain embodiments of the fifth aspect, the water purification apparatus further comprises an ultrasonic radiation, microwave radiation, magnetic field or electric current generator configured to expose the coating layer to ultrasonic radiation, microwave radiation, a magnetic field or an electric current when activated.

The methods of the invention are particularly suitable for use in separation systems, such as RO, FO, NF, ED, EDR and MCDI systems, that are designed to maximise the recovery of product water from feed water from a cross-flow separation membrane based apparatus using a control system to continually drive the membrane at or beyond the threshold of scaling based on membrane operating conditions rather than a control system based on set-points pre-determined from a membrane manufacturer's design guidelines. Thus, in a sixth aspect the present invention provides a method for improving the recovery of purified water from a water purification apparatus, the method comprising:
(a) passing feed water containing scale forming materials through a separation membrane according to the second aspect of the invention to separate at least some of the scale forming materials from the feed water;
(b) altering one or more parameters of the apparatus until the scale forming materials form a scale on a portion of the membrane;
(c) continually monitoring the apparatus to detect the scale formation, thereby identifying a scaling threshold of the apparatus;
(d) maintaining the apparatus at or beyond the scaling threshold by altering one or more parameters where necessary;
(e) recovering purified permeate water which passes through the filter; and
(f) when necessary, stopping step (a) and then contacting a concentrate side of the membrane with heated cleaning water at an elevated temperature that is above the standard operating temperature of the membrane or a fluid containing at least one degrading agent or ultrasonic radiation, microwave radiation, magnetic field or electric current for a period of time sufficient to remove or reduce scaling on the membrane;
(g) discharging spent cleaning water from the concentrate side of the membrane; and
(h) returning permeate water which passes through the membrane to the feed water.

The processes described herein enable operation of the water purification apparatus at or beyond the membrane scaling threshold to maximise product water recovery and recovery of the membrane once one or more of the operating parameters of the apparatus are sufficiently affected by scale formation on the membrane.

Certain embodiments of the processes described herein in which the coating layer is thermally, physically or electrically degradable provide the advantage that the cleaning water that passes through the membrane does not contain added acid, alkali, complexing agents or other aggressive chemicals and therefore can either be returned to waste and/or recycled through the separation system.

### BRIEF DESCRIPTION OF DRAWINGS

Embodiments of the present invention will be discussed with reference to the accompanying drawings wherein:

FIG. 1 is a schematic diagram of an embodiment of a water purification apparatus of the invention;

FIG. 2 is a schematic diagram of another embodiment of a water purification system of the invention;

FIG. 3 is a plot showing a comparison of the flux through a tannic acid coated membrane formed according to Example 1 at approximately 55 bar for a 32.9 g/L NaCl solution for 15 minutes of operation;

FIG. 4 is a plot showing flux measurements during the three coatings of the membrane of Example 1 with tannic acid. The variation in flux during runs is due to small variations in TMP;

FIG. 5 is a plot showing a comparison of the flux through a PVP coated membrane formed according to Example 2 at approximately 55 bar for a 3.34 wt % NaCl solution for 15 minutes of operation;

FIG. 6 is a plot showing flux measurements during three coatings of a membrane with PVP. The variation in flux during runs is due to small variations in TMP;

FIG. 7 shows flux measurements for a membrane having a tannic acid coating on top of a three layer PVP coating;

FIG. 8 is a plot showing a comparison of the flux through a poly(hexamethylenebiguanide) hydrochloride coated membrane formed according to Example 3 at approximately 55 bar for a 3.34 wt % NaCl solution for 15 minutes of operation;

FIG. 9 shows flux measurements for a membrane having a poly(hexamethylenebiguanide) hydrochloride coating;

FIG. 10 is a plot showing a comparison of the flux through molasses coated membrane formed according to Example 4 at approximately 55 bar for a 3.34 wt % NaCl solution for 15 minutes of operation;

FIG. 11 shows flux measurements on a first coating with different molasses concentrations. The experiments were performed on the same membrane in ascending order with each run (except the first) lasting for 30 min. The first run was performed for 3 hours; and

FIG. 12 shows the flux of a 10000 ppm molasses solution used for coating in the three runs.

### DESCRIPTION OF EMBODIMENTS

Scale formation occurs on the concentrate side of RO, FO, NF, ED, EDR and MCDI separation membranes because the concentration of solutes increases on the concentrate side of the membrane during the separation process, leading to precipitation of one or more of the dissolved solids and the formation of scale on the concentrate side of the membrane. This precipitation can cause plugging of the membrane thus lowering the efficiency of the process and total failure in extreme cases. Scale formation is especially problematic with feed waters that have a high concentration of calcium or magnesium salts or for high water recovery separation systems, such as the one described in Australian Patent No. 2007262651 (the “brine squeezer” system).

Described herein is a method for controlling scale and/or fouling on a separation membrane. The method comprises forming a thermally, physically, electrically or chemically degradable coating layer on the membrane; using the membrane under conditions that result in the formation of scale and/or fouling species on the membrane; and removing at least some of the scale and/or fouling species from the membrane by thermally, physically, electrically or chemically degrading the coating layer.

Also described herein is a separation membrane comprising a membrane and a coating layer on the membrane. The coating layer is thermally, physically, electrically or chemically degradable whereby degradation of the coating layer results in removal of at least some of the scale and/or fouling species from the membrane.

In the case of membranes comprising a thermally degradable coating layer, hot (i.e. 40° C. to 99° C.) water can be conveniently used to flush the membrane during a membrane cleaning cycle. Whilst water is particularly suitable for this purpose it is contemplated that other fluids (including liquids) could also be used. It is preferable that the fluid is environmentally acceptable or benign. Other suitable fluids could include alcohols and related solvents. For the purposes of further discussion reference will be made to the use of heated water. However, in light of the above discussion it will be appreciated that the present disclosure is not limited to that particular embodiment and other fluids could be used in place of water.

In the case of membranes comprising a chemically degradable coating layer, a fluid such as water containing at least one coating layer degrading agent can be conveniently used to flush the membrane during a membrane cleaning cycle. Water containing the degrading agent(s) is particularly suitable for this purpose but it is contemplated that other fluids (including liquids), such as alcohols, could also be used. The degrading agent can be any molecular or ionic species that reacts with the coating layer to degrade the layer. Suitable degrading agents include, but are not limited to, acids such as hydrochloric acid, methanesulfonic acid and sulfuric acid, alkalis such as sodium hydroxide and trisodium phosphate, salts such as sodium chloride, complexing agents such as ethylenediamine acetic acid and aminotris(methylenephosphonic acid), and organic species such as sodium polyacrylate and lignin.

In the case of membranes comprising a physically degradable coating layer, ultrasonic radiation, microwave radiation or a magnetic field can be conveniently used to degrade the coating layer to release the coating layer and scale or fouling species from the membrane during a membrane cleaning cycle. Optionally, a fluid, such as water, may be passed over or through the membrane during said cleaning cycle is assist in removal and the coating layer, scale and fouling species.

In the case of membranes comprising an electrically degradable coating layer, an electric current can be conveniently used to degrade the coating layer to release the coating layer and scale or fouling species from the membrane during a membrane cleaning cycle. Optionally, a fluid, such as water, may be passed over or through the membrane during said cleaning cycle is assist in removal and the coating layer, scale and fouling species.

Conveniently, the membrane is contacted with heated water, the fluid containing the degrading agent(s), the ultrasonic radiation, the microwave radiation, the magnetic field and/or the electric current when the membrane is in situ by feeding the heated water and/or the fluid containing the degrading agent(s) into a water purification apparatus containing the membrane on a concentrate side of the membrane or by exposing the membrane to ultrasonic radiation, microwave radiation, a magnetic field or an electric current. This means that scale can be removed from the membrane without removing the membrane from the apparatus. Thus, the present invention also provides a method of cleaning a separation membrane according to the invention to remove or reduce scale and/or fouling species therefrom, the method comprising contacting the membrane with a heated fluid at an elevated temperature that is above the standard operating temperature of the membrane, contacting the membrane with a fluid containing at least one degrading agent or exposing the membrane to ultrasonic radiation, microwave radiation, a magnetic field or an electric current for a predetermined period of time to thermally, physically, electrically and/or chemically degrade the coating layer and remove at least some of the scale and/or fouling species from the membrane.

The scale forming materials of concern include, but are not limited to, calcium carbonate, calcium sulfate, strontium sulfate, barium sulfate, calcium fluoride, iron hydroxide, and silica. Without intending to be bound by any specific theory on the mechanism of action, we propose that the heated water, the at least one degrading agent, the ultrasonic radiation, the microwave radiation, the magnetic field or the electric current cause the coating layer to degrade. This results in the coating layer separating from the membrane. Consequently, any scale and/or fouling species attached to the coating layer are also removed. Heated water (if used) may also cause the membrane to stretch and this then also causes or assists in the degradation of the coating layer and may also assist by physically breaking down the scale on the surface of the membrane. Furthermore, the scaling layer is a complex amalgam of numerous species including scaling salts, organics etc and not only does the hot water thermally degrade the underlying coating but also helps dissolve the accumulated scaling/fouling amalgam that is on the surface of the coating. In this way, both soluble and the insoluble scale forming materials are removed from the surface of the membrane.

Optionally, the heated water that is contacted with the membrane may contain one or more cleaning additives. Cleaning additives suitable for this purpose include, but are not limited to, acids, alkalis, chelating agents, surfactants and detergents. Adding an amount of cleaning additive to the heated water may improve the effectiveness of the clean. At elevated temperature, the effectiveness of the cleaning additive may be enhanced and, on this basis, lower concentrations of additives may be required to be effective and, therefore, any final effluent will have lower than normal concentrations of additives and will be easier to manage.

Optionally, a gas may be added to the heated water. The gas bubbles in the heated water may assist with agitation of the heated water which may, in turn, enhance the effectiveness of the cleaning step. Gases such as air, carbon dioxide or nitrogen may be used and they may be added to the heated water using a bubbler and pump connected to a suitable gas supply.

The heated water and/or the fluid containing the degrading agent(s) is contacted with the membrane or the membrane is exposed to ultrasonic radiation, microwave radiation, a magnetic field or an electric current for predetermined period of time that is sufficient to remove at least some of the scale from the surface of the membrane. It will be appreciated that it may not be necessary to remove all of the scale from the membrane in order for the cleaning step to be effective. The predetermined period of time depends on the amount of scaling or fouling on the membrane, the nature of the coating layer, the chemistry of the scaling or fouling species, the temperature of the heated water, the cross-flow velocity of the heated water on the membrane, the presence of chemical additives in the heated water, the strength of the ultrasonic radiation, microwave radiation or a magnetic field, electric current, etc. This time period can be determined on a case by case basis.

The method described can be used to control scale formation on separation membranes. Formation of scale on the separation membrane can be detected and, once a threshold level of scale formation is detected, a membrane cleaning cycle comprising contacting the membrane with heated water at an elevated temperature that is above the standard operating temperature of the membrane or the fluid containing the degrading agent(s) for a predetermined period of time, or exposing the membrane to ultrasonic radiation, microwave radiation, a magnetic field or an electric current can be initiated.

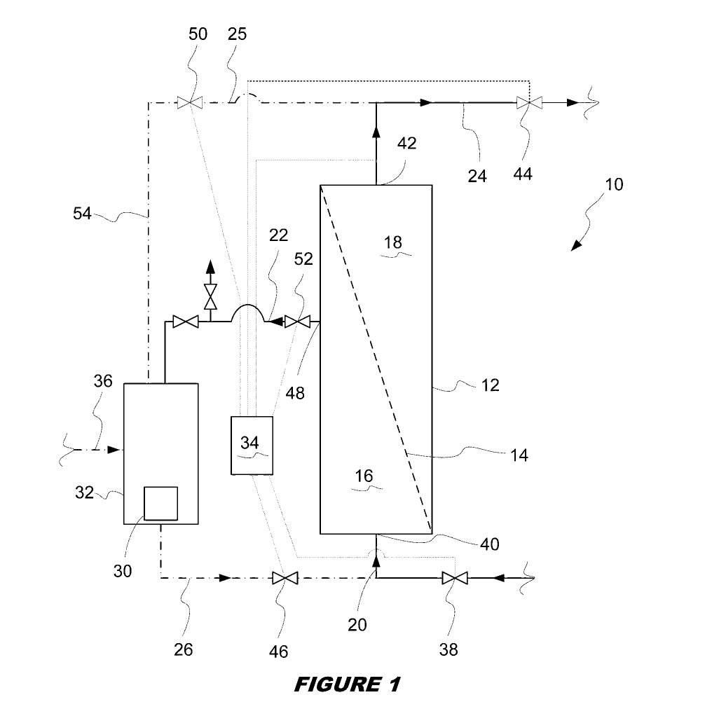

Referring now to FIG. 1, there is shown a water purification apparatus 10 for purifying water using a reverse osmosis process. The apparatus 10 includes a reverse osmosis (RO) separation unit 12 comprising a separation membrane 14 separating a concentrate side 16 from a permeate side 18 and a cleaning arrangement for removing or reducing scale from the separation membrane 14 during a cleaning cycle. The separation membrane 14 has a coating layer that is thermally, physically, electrically and/or chemically degradable. It will be appreciated that an RO separation membrane 14 is described in the illustrated embodiments but the membrane could also be an FO, NF or IX membrane.

The concentrate side 16 of the separation unit 12 is configured to receive, during a purifying cycle, water from a feed water supply line 20 and to discharge water not passed through the membrane via a concentrate line 22. The permeate side 18 of the separation unit 12 is configured to discharge permeate water that has passed through the membrane 14 via a permeate line 24.

The concentrate side 16 of the separation unit 12 is also configured to receive, during a cleaning cycle, heated cleaning water at an elevated temperature that is above the standard operating temperature of the membrane from a water supply line 26 and to discharge water via the concentrate line 22 and return it to the water supply line 26 directly or indirectly via cleaning water storage tank 32. The permeate side 18 of the separation unit 12 is configured to return any permeate water that has passed through the membrane 14 during the cleaning cycle to the water supply line 26 directly or indirectly via cleaning water storage tank 32. The system is also configured to return concentrate from the purifying cycle via concentrate line 22 to the water supply line 26 directly or indirectly via cleaning water storage tank 32.

In embodiments that are not illustrated, the concentrate side 16 of the separation unit 12 is also configured to receive, during a cleaning cycle, a fluid containing at least one degrading agent from a water supply line 26 and to discharge water via the concentrate line 22 and return it to the water supply line 26 directly or indirectly via cleaning water storage tank 32. In these embodiments, the separation unit 12 further comprises a scale removal unit (not illustrated) to introduce a coating degrading agent into the membrane to chemically degrade the coating layer and reduce the amount of scale on the membrane.

In the illustrated embodiments, a heater 30 is configured to heat the cleaning water to a temperature of from about 40° C. to about 99° C. The heater 30 is in fluid connection with the water supply line 26. The heater 30 may be an instantaneous heater that heats the cleaning water directly in the supply line. Alternatively, as shown in FIG. 1, the heater may be operatively connected to cleaning water storage tank 32 so that is heats the water stored in the tank 32. The tank 32 may include a thermostat (not shown) to regulate the temperature of the cleaning water in the tank at a temperature of from about 40° C. to about 99° C. The temperature of the cleaning water is preferably at least about 10° C. higher than the standard operating temperature of the membrane, more preferably at least about 15° C. higher than the standard operating temperature of the membrane, and most preferably about 20° C. higher than the standard operating temperature of the membrane. For example, if the standard operating temperature of the membrane is 20° C. then the temperature of the cleaning water may be about 45° C. In specific embodiments, the temperature of the cleaning water is about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 56° C., about 57° C., about 58° C., about 59° C., about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., about 80° C., about 81° C., about 82° C., about 83° C., about 84° C., about 85° C., about 86° C., about 87° C., about 88° C., about 89° C., about 90° C., about 91° C., about 92° C., about 93° C., about 94° C., about 95° C., about 96° C., about 97° C., about 98° C. or about 99° C. Preferably, the temperature of the cleaning water is about 80° C.

The coating layer is formed from any material that adheres to the membrane surface without substantially affecting the separation characteristics of the membrane and degrades at the elevated temperature that is above the standard operating temperature of the membrane. It will be appreciated that for most RO, FO, NF, ED, EDR and MCDI separation systems, the “standard operating temperature” is the temperature of the membrane during the separation process and is typically in the range of 5° C. to 45° C. In embodiments, the coating layer can be either an organic or inorganic material. The coating material is chosen so that the coating layer thermally degrades at the elevated temperature that is above the standard operating temperature of the membrane. As used herein, the term “thermally degrades” and related terms means that there is a change in a chemical or physical parameter of the material used in the coating layer at the elevated temperature such that the physical structure of the coating changes. Thermal degradation is intended to include a change in physical state, such as melting of the material of the coating layer at the elevated temperature. In these cases, the chemical composition of the material of the coating layer may be unchanged in the different states. In other cases, thermal degradation may be a chemical change in the material of the coating layer. For example, a polymeric coating material may be chemically degraded at the elevated temperature. The chemical degradation may result in the breaking of bonds in the polymer to yield lower molecular weight monomeric or polymeric species. The lower molecular weight monomeric or polymeric species may be soluble in the heated water. Thermal degradation could also be the material of the coating layer dissolving in the heated water.

A wide range of materials can be used to form the coating layer, with the selection of a suitable material depending primarily on the stability of the material under the standard operating conditions of the membrane (e.g. temperature, pressure, chemical characteristics of the feed water, etc), the solubility, stability, phase, etc of the material at the elevated temperature, the reactivity of the material to a specific coating layer degrading agent, stability of the material to ultrasonic radiation, microwave radiation, magnetic fields, electric currents, etc. The material may be an inorganic or an organic material. Suitable materials include, but are not limited to, polymers, enzymes, proteins, tannic acids, carbohydrates, fatty acids, and surfactants.

Enzymes, such as lipases, can be coated onto the membrane using known methods or variations thereof (Hyo et al., 2011).

Tannic acid coatings can be formed using known methods or variations thereof (Ejima et al., 2013). For example, an RO membrane can be coated with tannic acid by contacting at least a concentrate side of the membrane with an aqueous solution containing tannic acid.

Carbohydrate or sugar coatings can be formed using known methods or variations thereof. For example, a molasses coating can be formed on the membrane.

Fatty acid coatings can be formed using known methods or variations thereof (Hu et al., 2009).

Surfactant coatings can be formed using known methods or variations thereof (Karsa, 2003).

The coating material may be a homopolymer, copolymer or polymer blend comprising any one or more of polymethylmethacrylates, polystyrenes, polycarbonates, polyimides, epoxy resins, cyclic olefin copolymers, cyclic olefin polymers, acrylate polymers, polyethylene terephthalate, polyphenylene vinylene, polyether ether ketone, poly (N-vinylcarbazole), acrylonitrile-styrene copolymer, polyetherimide poly(phenylenevinylene)polysulfone, copolymer of styrene and acrylonitrile poly(arylene oxide), polycarbonate, cellulose acetate, polysulfones; poly(styrenes), styrene-containing copolymers, acrylonitrilestyrene copolymers, styrene-butadiene copolymers, styrene-vinylbenzylhalide copolymers; polycarbonates; cellulosic polymers, cellulose acetate-butyrate, cellulose propionate, ethyl cellulose, methyl cellulose, nitrocellulose, polyamides, polyimides, aryl polyamides, aryl polyimides, polyethers, poly(arylene oxides), poly(phenylene oxide), poly(xylene oxide); poly(esteramide-diisocyanate), polyurethanes, polyesters (including polyarylates), poly(ethylene terephthalate), poly(alkyl methacrylates), poly(acrylates), poly(phenylene terephthalate), polysulfides, poly (ethylene), poly(propylene), poly(butene-l), poly(4-methyl pentene-1), polyvinyls, poly(vinyl chloride), poly(vinyl fluoride), poly(vinylidene chloride), poly(vinylidene fluoride), poly(vinyl alcohol), poly(vinyl esters), poly(vinyl acetate), poly(vinyl propionate), poly(vinyl pyridines), poly(vinyl pyrrolidones), poly(vinyl ethers), poly(vinyl ketones), poly(vinyl aldehydes), poly(vinyl formal), poly(vinyl butyral), poly(vinyl amides), poly(vinyl amines), poly(vinyl urethanes), poly(vinyl ureas), poly(vinyl phosphates), poly(vinyl sulfates), polyallyls; poly(benzobenzimidazole), polyhydrazides, polyoxadiazoles, polytriazoles, poly (benzimidazole), polycarbodiimides, polyphosphazines, poly (biguanides) and combinations thereof. In certain specific embodiments, the coating material is poly(vinyl alcohol). In other specific embodiments, the coating material is poly(vinyl pyrrolidone). In still other specific embodiments, the coating material is poly(hexamethylenebiguanide) hydrochloride.

The coating layer can be applied to the membrane 14 using any of the procedures known in the art for coating membranes. For example, the coating methods described in U.S. Pat. No. 8,017,050 can be used. In a typical coating procedure, a solution of a coating agent is recirculated around the feed/concentrate side of the membrane for a period of time and the membrane is then flushed to remove excess coating agent before starting an operating cycle. A preparation and application unit (not shown) may be in fluid connection with the feed water supply line 26 in order to introduce the coating agent to the feed/concentrate side of the membrane.

Alternatively, or in addition, the coating agent may be added to a feed water supply line using a preparation and application unit in fluid connection with the feed water supply line. The preparation and application unit is configured to introduce the coating agent to the feed water to coat the membrane. In these embodiments, the coating agent can be introduced continuously to the membrane using feed water.

The membrane 14 can be coated and-recoated using permeate or feed water at >10 bar.

The apparatus 10 further comprises a controller 34 operatively connected to the feed water supply line 20, the concentrate line 22, the permeate line 24 and configured to regulate the flow of water through said lines so that the apparatus 10 can be operated in a purifying cycle during which purified water is produced and a cleaning cycle during which scale on the membrane 14 is removed or reduced.

The cleaning water storage tank 32 is connected to a clean water inlet line 36 which is, in turn, connected to a source of clean water (not shown). The cleaning water storage tank 32 is also connected to concentrate line 22 and the permeate line 24 so that concentrate water and/or the permeate water from the cleaning cycle can be reused.

In the purifying cycle, valve 38 is opened and feed water enters the concentrate side 16 of the separation unit 12 via feed water supply line 20 and inlet 40. Permeate water that is purified by passing through membrane 14 then exits the reverse osmosis unit 12 via outlet 42 and passes through permeate line 24 to storage or any other end use. During the purifying cycle, valves 38 and 44 are open and valves 46 and 50 are shut. As required, concentrate water on the concentrate side of membrane 14 is removed from the reverse osmosis unit 12 via concentrate outlet 48 and concentrate line 22. The concentrate is normally returned to the cleaning water storage tank 32 for re-use in the cleaning cycle. As alternatives, the concentrate can be discarded to drain or transferred to another processing device such as another reverse osmosis membrane unit or a solar distillation apparatus, etc. The operation of the apparatus 10 during the purifying cycle will be understood to be a standard operation used in reverse osmosis units and standard operating parameters, such as pressure, time, temperature, additives etc., for such systems are used. In some embodiments, the operating parameters during the purifying cycle may be those described in Australian Patent No. 2007262651 whereby the apparatus 10 is operated at or above the membrane scaling threshold to maximize permeate water recovery. The operation of the apparatus 10 is controlled by a system controller (not shown).

At the conclusion of a purifying cycle, valve 38 is closed to terminate the flow of feed water and cleaning water control valve 46 is opened to start the flow of heated cleaning water into the concentrate side 16 of separation unit 12. Concentrate control valve 52 is also opened. The heated cleaning water contacts the membrane 14 and thermally degrades the coating layer, thereby disrupting the scale on the concentrate side of the membrane. Turbulence caused by entry of the cleaning water may assist by also physically dislodging scale from the surface of the membrane 14. Cleaning water containing dissolved and/or suspended scale forming materials and products of the thermal degradation of the coating layer then passes through concentrate outlet 48 and is transferred to cleaning water storage tank 32 via concentrate line 22. Some of the salts that form scale, such as calcium carbonate, will not dissolve in the heated cleaning water and, in fact, their solubility decreases at higher temperatures. Table 1 shows a range of scale forming salts commonly found in sea water, brackish water and the like. Despite this, we have found that the method described herein can be used practically to remove even these salts.

TABLE 1
Solubility of several scale forming species

| Scale forming | | | | Solubility change with |
|---|---|---|---|---|
| species | Formula | Mineral | pKₛₚ at 25° C. | temperature increase |
| Calcium carbonate | CaCO₃ | Calcite | 8.37 | Decreases |
| Calcium sulfate | CaSO₄•2H₂O | Gypsum | 4.58 | Increases between 20° C. |
| | | | | to 30° C., then decreases |
| Barium sulfate | BaSO₄ | Barite | 9.97 | Increases |
| Strontium sulfate | SrO₄ | Celestite | 6.65 | Increases then decreases |
| Silica | SiO₂ | Amorphous | 2.71 | Increases |
| | | silica | | |
| Calcium phosphate | Ca₃(PO₄)₂ | Whitlockite | 32.68 | Decreases |
| Calcium fluoride | CaF₂ | Fluorite | 10.4 | Increases |

Permeate water that passes through the membrane 14 during the cleaning cycle exits the reverse osmosis unit 12 via permeate outlet 42 and passes through permeate line 25 which returns the permeate water to the cleaning water storage tank 32 via return line 54. In other embodiments that are not illustrated, permeate line 24 may also be configured to return permeate water to the feed water supply line 20 via a return line.

Optionally, the direction of flow of water into the separation unit 12 can be reversed during the purifying cycle and/or the cleaning cycle. In this case, the incoming water may enter the unit from concentrate line 22 or permeate line 24 and exit via the feed water supply line 20 or concentrate line 22, respectively. This may be done to disrupt the fouling layers and improve cleaning efficiency.

The cleaning cycle is initiated when certain parameters indicate that the performance of the membrane separation plant will become irreversibly scaled or fouled, or by other routine parameters such as time interval to prevent irreversible scaling/fouling from occurring.

As mentioned, controller 34 is used to monitor the system operation and initiate and terminate the purifying and cleaning cycles. The system controller controls valves 38, 44, 46, 50 and 52, heater 30 as well as pumps and other equipment required to operate the apparatus 10.

By using cleaning cycles, membrane plugging due to precipitation or compaction as well as membrane failure due to continuously applied fluid pressure, is substantially reduced.

In some embodiments, the apparatus 10 is operated continuously at high temperature. From a processing point of view, this may be particularly advantageous if there is to be post treatment of the concentrate by a thermal process to concentrate the fluid even further possibly to a solid crystal state.

In an alternative, at the conclusion of a purifying cycle, valve 38 is closed to terminate the flow of feed water and cleaning water control valve 46 is opened to start a flow of cleaning water containing at least one degrading agent, such as a complexing agent, into the concentrate side 16 of separation unit 12. Concentrate control valve 52 is also opened. The cleaning water contacts the membrane 14 and chemically degrades the coating layer, thereby disrupting the scale on the concentrate side of the membrane. Turbulence caused by entry of the cleaning water may assist by also physically dislodging scale from the surface of the membrane 14. Cleaning water containing unreacted degrading agent, dissolved and/or suspended scale forming materials and products of the thermal degradation of the coating layer then passes through concentrate outlet 48 and is transferred to cleaning water storage tank 32 via concentrate line 22.

Alternatively still, at the conclusion of a purifying cycle, valve 38 is closed to terminate the flow of feed water and the membrane and coating layer are exposed to ultrasonic radiation, microwave radiation, a magnetic field or an electric current under conditions to physically disrupt the coating layer. In these embodiments, the apparatus 10 includes a power supply, an ultrasonic transducer and vibrating head are connected to the RO vessel 12 so that the membrane 14 is exposed to ultrasonic radiation.

Throughout this specification reference is made to methods and apparatus for purifying water. It will be understood by the skilled person that the water may be sea water, brackish water or another water containing liquid from which materials are desirously removed, e.g. wine.

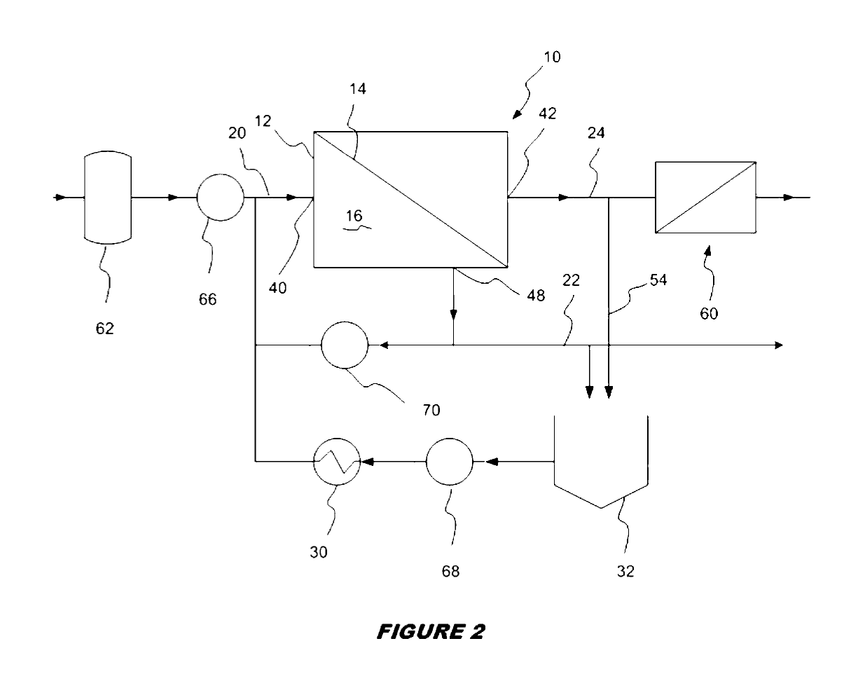

FIG. 2 shows a water purification apparatus 10 that is based on the separation system described in Australian Patent No. 2007262651. The apparatus 10 operates at or the membrane scaling threshold to maximise permeate water recovery. In a purifying cycle feed water enters the concentrate side 16 of separation unit 12 via feed water supply line 20, squeezer pump 66, and inlet 40. Permeate water that is purified by passing through membrane 14 then exits the reverse osmosis unit 12 via outlet 42 and passes through permeate line 24 to storage, a second pass purification unit 60, or any other end use. One or more parameters of the apparatus are altered until the scale forming materials form a scale on a portion of the membrane 14. The apparatus 10 is continually monitored to detect the scale formation, thereby identifying a scaling threshold. The apparatus 10 is maintained at or above the scaling threshold by altering one or more parameters where necessary. When necessary, the purifying cycle is terminated and a cleaning cycle commenced. The cleaning cycle comprises contacting the membrane 14 with heated water at a temperature of from about 40° C. to about 99° C. for a period of time sufficient to remove or reduce scaling on the membrane. The heated water passes through heater 30 and is sourced from cleaning water storage tank 32 and is pumped to feed water supply line 20 by cleaning pump 68. The cleaning water may be made up with concentrate water that is not heated but is mixed with heated cleaning water using cross flow pump 70. Cleaning permeate water which passes through the membrane during the cleaning cycle is recovered and returned to the feed water via cleaning water storage tank 32. The heated cleaning water contacts the membrane 14 and thermally degrades the coating layer, thereby disrupting the scale on the concentrate side of the membrane. Cleaning water containing dissolved and/or suspended scale forming materials and products of the thermal degradation of the coating layer then passes through concentrate outlet 48 and is transferred to cleaning water storage tank 32 via concentrate line 22.

Permeate water that passes through the membrane 14 during the cleaning cycle exits the reverse osmosis unit 12 via permeate outlet 42 and passes through permeate line 24 which returns the permeate water to the cleaning water storage tank 32 via return line 54.

The parameter of the apparatus which is altered may be the flow rate of permeate water, the recovery rate of the permeate water, the pressure difference between the inlet and the permeate outlet, and the feed pressure of the feed water.

The step of monitoring the apparatus may include monitoring a decrease in the flow of permeate water, a decrease in the recovery rate of permeate water, an increase in the pressure difference between the inlet and the permeate or concentrate outlets, an increase in the pressure of the feed water, and/or an increase in the conductivity of the permeate water.

Optionally, permeate water which passes through the membrane 14 in the purifying cycle passes to a second pass purification apparatus 60 where it is purified further.

Optionally, the feed water containing scale forming materials may undergo pre-treatment in a pre-treatment apparatus 62 which may include but is not limited to a media filter and/or chemical dosage stages in which chemical additives are added to the water to remove specific materials or alter solubility of the impurities.

### EXAMPLES

### Example 1—Tannic Acid Coating

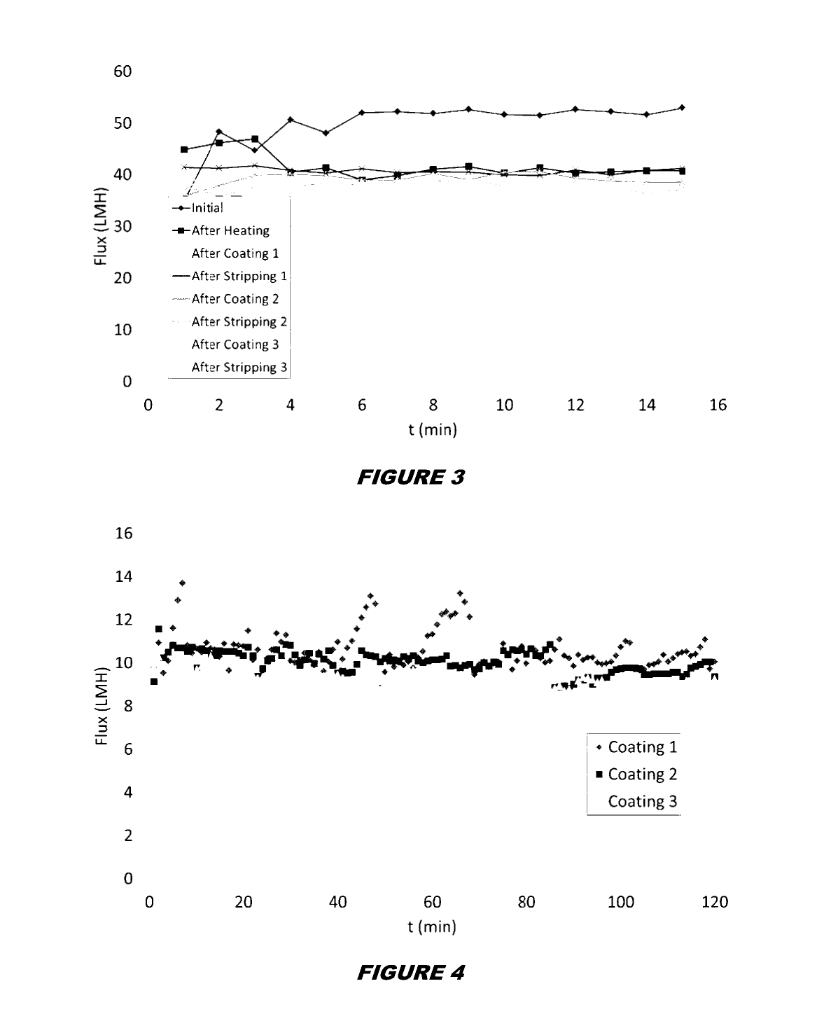

A flat sheet seawater membrane with a large feed spacer was coated with a solution of 30 ppm tannic acid at 10 bar for 2 hours. The flux at approximately 55 bar was then measured for a 32.9 g/L NaCl solution for 15 minutes of operation. The results are shown in FIGS. 3 and 4 and Table 2. The initial membrane had been compressed for 1 hour at 60 bar prior to operation. Heating was performed at 80° C. for 1 hr (heating rate was approximately 1-1.5° C./min, cooling was approximately 0.75° C./min). Stripping was performed at 80° C. for 1 hour similar to the heating run.

TABLE 2
Comparison of rejection calculated from conductivity

| Treatment | Rejection (%) |
|---|---|
| Initial | 98.5 |
| After Heating | 86.4 |
| After Coating 1 | 95.3 |
| After Stripping 1 | 95.6 |
| After Coating 2 | 97.5 |
| After Stripping 2 | 97.8 |
| After Coating 3 | 97.3 |
| After Stripping 3 | 96.2 |

### Example 2—Polyvinylpyrrolidone Coating

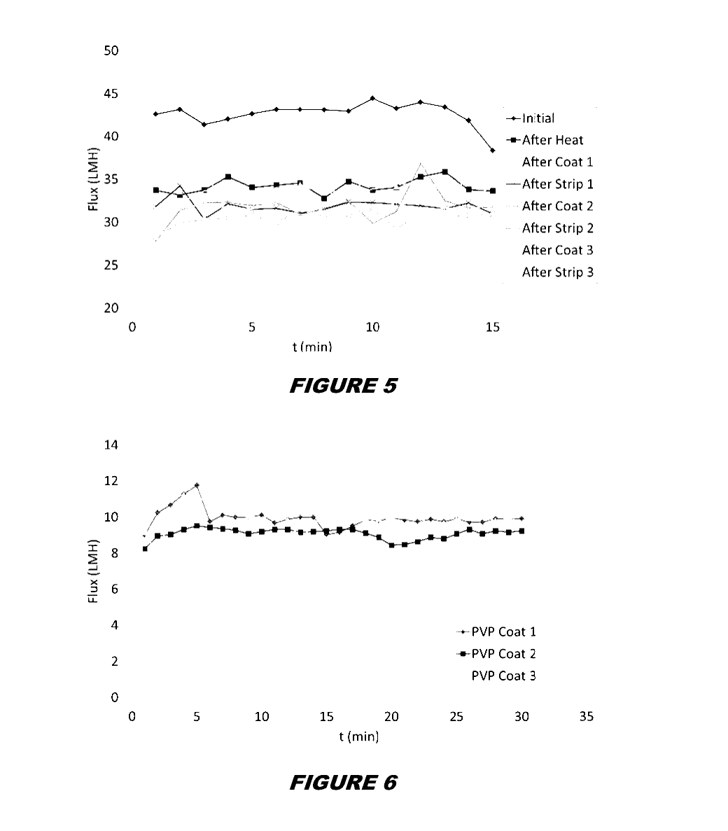

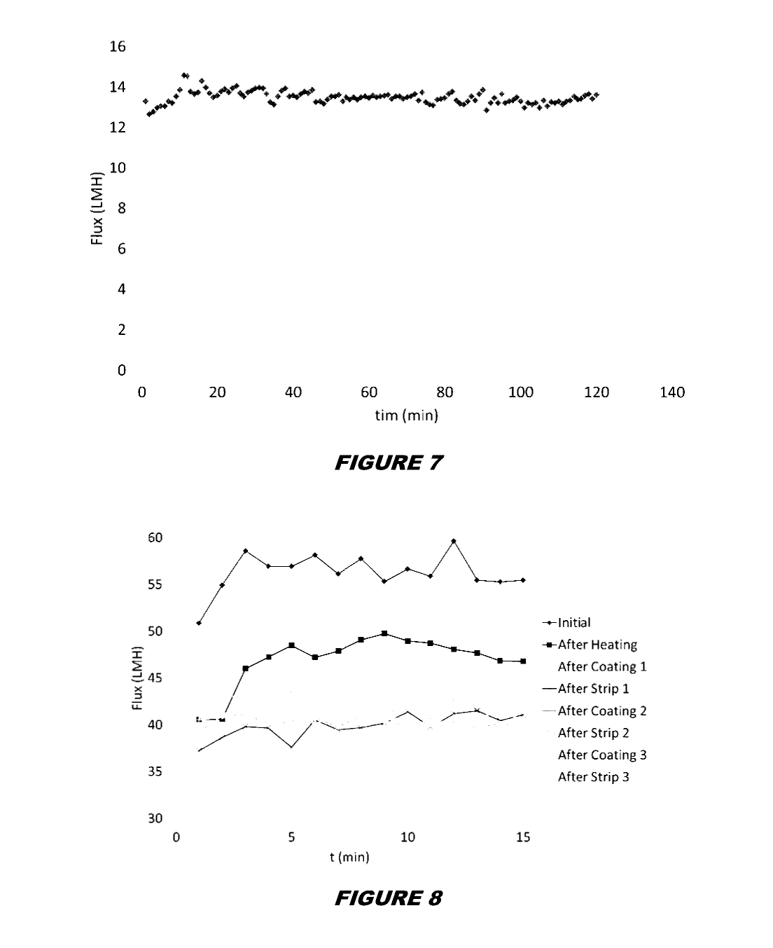

A flat sheet seawater membrane with a large feed spacer was coated with a solution of 30 ppm polyvinylpyrrolidone at 10 bar for 30 minutes. The flux at approximately 55 bar was then measured for a 3.34 wt % NaCl solution for 15 minutes of operation. The results are shown in FIGS. 5 to 7 and Table 3. The initial membrane had been compressed for 1 hour at 55-60 bar prior to operation. Heating was performed at 80° C. for 1 hr (heating rate was approximately 1-1.5° C./min, cooling was approximately 0.75° C./min). Stripping experiments were performed using the conditions of the heat treatment.

TABLE 3
Comparison of rejection calculated
from conductivity for PVP coatings

| Treatment | Rejection (%) |
|---|---|
| Initial | 98.9 |
| After Heating | 98.0 |
| After Coating 1 | 98.5 |
| After Stripping 1 | 97.2 |
| After Coating 2 | 98.3 |
| After Stripping 2 | 97.1 |
| After Coating 3 | 99.4 |
| After Stripping 3 | 98.7 |

### Example 3—Poly(Hexamethylenebiguanide) Hydrochloride Coating

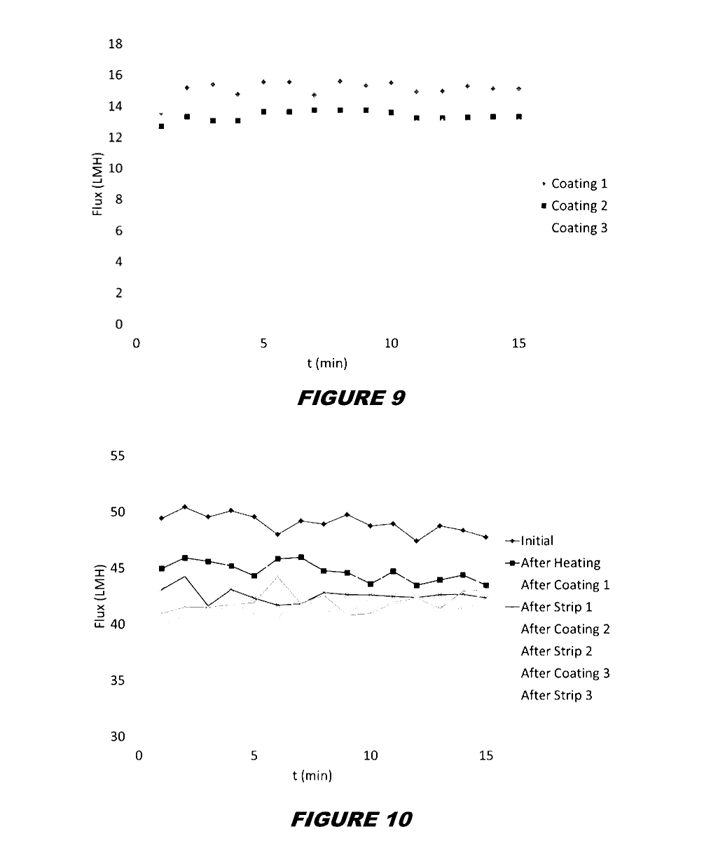

A flat sheet seawater membrane with a large feed spacer was coated with a solution of 7 ppm poly(hexamethylenebiguanide) hydrochloride at 8% recovery. The flux at approximately 55 bar was measured for a 3.34 wt % NaCl solution for 15 minutes of operation. The results are shown in FIGS. 8 and 9 and Table 4. The initial membrane had been compressed for 1 hour at 55-60 bar prior to operation. Heating was performed at 80° C. for 1 hr (heating rate was approximately 1-1.5° C./min, cooling was approximately 0.75° C./min). Coatings 1, 2 and 3 was performed using a 7.9, 8.6 and 8.0 ppm solution of poly(hexamethylenebiguanide) hydrochloride respectively, at 10 bar for approximately 15 minutes. Stripping experiments were performed using the conditions of the heat treatment. For reasons beyond the control of the experimentalist, the first strip lasted for 2 hours rather than 1.

TABLE 4
Comparison of rejection calculated from conductivity for
poly(hexamethylenebiguanide) hydrochloride coatings

| Treatment | Rejection (%) |
|---|---|
| Initial | 99.5 |
| After Heating | 99.1 |
| After Coating 1 | 99.6 |
| After Stripping 1 | 98.9 |
| After Coating 2 | 99.4 |
| After Stripping 2 | 99.3 |
| After Coating 3 | 99.4 |
| After Stripping 3 | 99.2 |

### Example 4—Molasses Coating

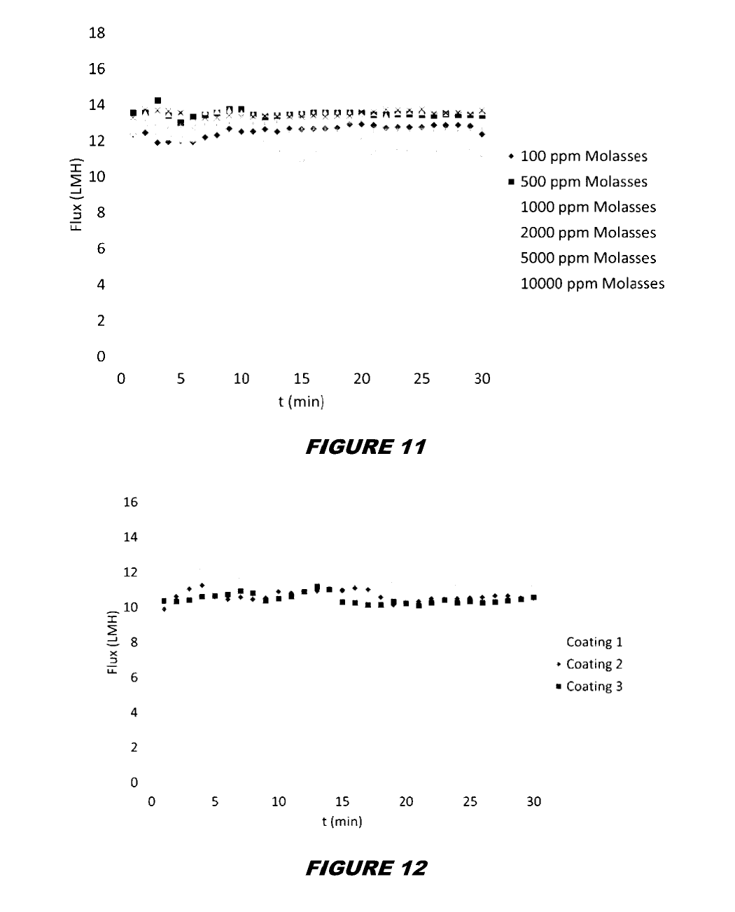

A flat sheet seawater membrane with a large feed spacer was coated with a solution of 10000 ppm molasses at 10 bar for 30 minutes. The flux at approximately 55 bar for a 3.34 wt % NaCl solution for 15 minutes of operation. The results are shown in FIGS. 10 to 12 and Table 5. The initial membrane had been compressed for 1 hour at 55-60 bar prior to operation. Heating was performed at 80° C. for 1 hr (heating rate was approximately 1-1.5° C./min, cooling was approximately 0.75° C./min). Strips were performed in the same way to the heat treatment.

TABLE 5
comparison of rejection calculated from
conductivity for molasses coatings

| Treatment | Rejection (%) |
|---|---|
| Initial | 98.8 |
| After Heating | 95.8 |
| After Coating 1 | 99.4 |
| After Stripping 1 | 98.8 |
| After Coating 2 | 99.4 |
| After Stripping 2 | 99.2 |
| After Coating 3 | 99.4 |
| After Stripping 3 | 99.2 |

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

### REFERENCES

Hirotaka Ejima, Joseph J. Richardson, Kang Liang, James P. Best, Martin P. van Koeverden, Georgina K. Such, Jiwei Cui, and Frank Caruso, Science 2013, 341(6142), 154-157.
Z Hu, X Zen, J Gong, Y Deng, Colloids and Surfaces A: Physicochemical and Engineering Aspects 2009, 351 (1-3), 65-70.
Hyo Jin An, Hye-Jin Lee, Seung-Hyun Jun, Sang Youn Hwang, Byoung Chan Kim, Kwanghee Kim, Kyung-Mi Lee, Min-Kyu Oh, and Jungbae Kim, Bioprocess and Biosystems Engineering 2011, 34 (7)7, 841-847.
David R Karsa, “Surfactants in Polymers, Coatings, Inks, and Adhesives” in Sheffield Annual Surfactants Review 2005 published by Blackwell.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. A separation membrane comprising a membrane and a coating layer on the membrane, wherein the coating layer is thermally, physically, electrically or chemically degradable whereby degradation of the coating layer results in removal of at least some of the scale and/or fouling species from the membrane.

23. The separation membrane according to claim 22, wherein the coating layer is formed from a material selected from the group consisting of: polymers, enzymes, proteins, tannic acids, fatty acids, carbohydrates and surfactants.

24. The separation membrane according to claim 23, wherein the coating layer is formed from a material selected from the group consisting of: poly(vinyl alcohol), poly(vinyl pyrrolidones), poly(biguanides), carbohydrates, and tannic acids.

25. The separation membrane according to claim 24, wherein the coating layer is formed from tannic acid.

26. The separation membrane according to claim 24, wherein the coating layer is formed from molasses.

27. The separation membrane according to claim 24, wherein the coating layer is formed from poly(vinyl pyrrolidone).

28. The separation membrane according to claim 24, wherein the coating layer is formed from poly(hexamethylenebiguanide) hydrochloride.

29. The separation membrane according to claim 22, wherein the coating layer is thermally degradable at an elevated temperature that is above the standard operating temperature of the membrane.

30. The separation membrane according to claim 22, wherein the coating layer is physically degradable and degrades when exposed to ultrasonic radiation, microwave radiation or a magnetic field.

31. The separation membrane according to claim 22, wherein the coating layer is electrically degradable and degrades when exposed to an electric current.

32. The separation membrane according to claim 22, wherein the coating layer is chemically degradable and degrades when in contact with the at least one degrading agent.

33. A method of cleaning the separation membrane according to claim 22 to remove or reduce scale and/or fouling species therefrom, the method comprising:
contacting the membrane with a heated fluid at an elevated temperature that is above the standard operating temperature of the membrane; and/or
contacting the membrane with a fluid containing at least one degrading agent; and/or
exposing the membrane to ultrasonic radiation, microwave radiation, a magnetic field or an electric current;
for a predetermined period of time to thermally, physically, electrically and/or chemically degrade the coating layer and remove at least some of the scale and/or fouling species from the membrane.

34. A method for controlling scale and/or fouling on the separation membrane according to claim 22, the method comprising detecting the formation of scale and/or fouling species on the membrane and, once a threshold level of scale and/or fouling formation is detected, initiating a membrane cleaning cycle comprising contacting the membrane with a heated fluid at an elevated temperature that is above the standard operating temperature of the membrane and/or a fluid containing at least one degrading agent and/or ultrasonic radiation, microwave radiation, a magnetic field or an electric current for a predetermined period of time to thermally, physically, electrically and/or chemically degrade the coating layer and remove at least some of the scale and/or fouling species from the membrane.

35. The method according to claim 34, wherein the heated fluid is water.

36. (canceled)

37. The method according to claim 35, wherein the temperature of the heated fluid is 10° C. higher than the standard operating temperature of the membrane.

38. (canceled)

39. (canceled)

40. The method according to claim 34, wherein the at least one degrading agent is a molecular or ionic species that reacts with the coating layer to degrade the layer.

41. The method according to claim 40, wherein the degrading agent is selected from one or more of the group consisting of acids, alkalis, salts, complexing agents, and organic species.

42. A water purification apparatus, comprising:
a separation unit comprising the separation membrane according to claim 22 separating a concentrate side from a permeate side, the concentrate side of the separation unit being configured to receive, during a purifying cycle, water from a feed water supply line and to discharge water not passed through the membrane via a concentrate line, and the permeate side of the separation unit being configured to discharge permeate water that has passed through the membrane via a permeate line;
the concentrate side of the separation unit being configured to receive, during a cleaning cycle, heated water at an elevated temperature that is above the standard operating temperature of the membrane from a water supply line or a fluid containing at least one degrading agent or ultrasonic radiation, microwave radiation, magnetic field or electric current and to discharge water via the concentrate line, and the permeate side of the separation unit being configured to return permeate water that has passed through the membrane to the feed water supply line;
a controller operatively connected to the feed water supply line, the concentrate line and the permeate line and configured to regulate the flow of water through said lines so that the apparatus can be operated in a purifying cycle during which purified water is produced and a cleaning cycle during which scale on the membrane is removed or reduced.

43. (canceled)

44. (canceled)

45. (canceled)

46. (canceled)

47. A method for improving the recovery of purified water from a water purification apparatus, the method comprising:
(a) passing feed water containing scale forming materials through the separation membrane according to claim 22 to separate at least some of the scale forming materials from the feed water;
(b) altering one or more parameters of the apparatus until the scale forming materials form a scale on a portion of the membrane;
(c) continually monitoring the apparatus to detect the scale formation, thereby identifying a scaling threshold of the apparatus;
(d) maintaining the apparatus at or beyond the scaling threshold by altering one or more parameters where necessary;
(e) recovering purified permeate water which passes through the filter; and
(f) when necessary, stopping step (a) and then contacting a concentrate side of the membrane with heated cleaning water at an elevated temperature that is above the standard operating temperature of the membrane or a fluid containing at least one degrading agent or ultrasonic radiation, microwave radiation, magnetic field or electric current for a period of time sufficient to remove or reduce scaling on the membrane;
(g) discharging spent cleaning water from the concentrate side of the membrane; and
(h) returning permeate water which passes through the membrane to the feed water.
